(19) United States
(12) Patent Application Publication
(10) Pub. No.: US 2007/0262156 A1
(43) Pub. Date: Nov. 15, 2007

(54) Functional module improvement structure for expanded and enhanced SIM card

(75) Inventors: Jessen Chen, Luzhu Shiang (TW); Bemard Wang, Longtan Shiang (TW)

Correspondence Address: TROXELL LAW OFFICE PLLC, SUITE 1404, 5205 LEESBURG PIKE, FALLS CHURCH, VA, 22041, US

(73) Assignees: Leison Technology Co., Ltd.; A-Men Technology Corporation

(21) Appl. No.: 11/430,841

(22) Filed: May 10, 2006

(51) Int. Cl. G06K 19/06

(52) U.S. Cl. 235/492

(57) ABSTRACT

This invention relates to a functional module structural improvement for expanded and enhanced SIM card comprising of an user identification module and a SIM card; the user identification module is formed by thin film circuit board, the surface is installed with electrical connection points and a control chip, the control chip is built in with: operational interface and functional selection items, application information of the original line number, and more than one sets of new number information, operational interfaces, functional selection items, application information; it can provide the user with more diversified and total functional interface application as well as multi-number selection and usage switching, the convenience and effectiveness of usage can thus be greatly enhanced.

### BACKGROUND OF THE INVENTION

1. Field of the Invention

This invention relates a technological project which can enhance SIM card function, speak in more detail, it means a functional module structure improvement for a expanded and enhanced SIM card, basically, an user identification module contains a thin film circuit board in association with a control chip, therefore, when user identification chip (SIM card) and user identification module are used together and fixed, through its connection to control chip through electrical connection point, it can provide the user with more diversified and total functional interface application as well as multi-number selection and usage switching, the convenience and effectiveness of usage can thus be greatly enhanced.

2. Description of the Prior Art

As technology keep moving forward, mobile phone has now become a necessity in the daily life of modem people, it's not uncommon for a single person to have more than two line numbers, however, no matter the number is from the same or different service provider, one mobile phone can only be used for one user identification card (SIM card), therefore, if one user has only one mobile, he/she might have to insert and pull out the user identification card very frequently, this could easily lead to the wear and damage of the user identification card or the insertion slot of the mobile phone. However, for user having more than one mobile phone, although he/she can put the different user identification card in different mobile, he/she will have to carry more than one mobile phones when goes out, it not only occupies space but also creates inconvenience. Therefore, some manufacturers make study and improvement on the following designs:

The general user identification module (4) is as shown in FIG. 1, it contains two accommodation slots (40) which can be inserted by more than one user identification chip (41), the general user identification module (4) is then combined and inserted to the mobile phone (5) so that the line number switching function can be reached.

The general user identification module is as shown in FIG. 2, it is a double insertion card user identification module originating from the original user identification module of a mobile phone further connected to a U shape circuit board (60) and sliding slot (61), therefore, during the use, two user identification cards (62) are inserted in one mobile phone (5), and the number switching function can thus be achieved.

However, no matter it's the expanded user identification card structure as shown in FIG. 1 or FIG. 2, it is only targeting for number switching purpose, the newly installed user identification chip can not be edited, amended, added or deleted, used to send message, or used for the telephone directory check, therefore, its convenience and practical use are indeed limited. Moreover, for the general user identification module as shown in FIG. 1, its inserted user identification chip is cut from the original user identification card, therefore, the appearance or inside of the chip could be easily damaged due to accident, which might lead to malfunction; furthermore, for the double insertion card user identification module as shown in FIG. 2, since the space within the original phone is limited and can not be changed, therefore, the increased structural thickness could lead to the worseness of sealing of the battery or the outer cover, the worst case is the incapability of sealing, therefore, both the practical use and appearance are affected.

Due to the drawbacks existed in the structure of the prior art expanded user identification card, the inventor of the current invention thus spent great efforts on the study and trial of the current invention based on many years of accumulated experiences and finally come up with this “Functional module structure improvement for expanded and enhanced SIM card” so as to solve the dilemma and difficult situations faced by the prior arts.

### SUMMARY OF THE INVENTION

Therefore, the major purpose of the current invention is to provide a functional module structure improvement for expanded and enhanced SIM card, it can not only provide the switching of multi-numbers (at most six), but also provide new user oepration interface and diversified additional functions, these include the data and functional selection and application of the original first user identification card and the data and functional selection and application of the newly added first˜sixth user identification card; it avoids the draw back of the prior art invention which has only number switching function (no data editing or data adding and deleting function can be done) when a new user identification card is added, meanwhile, the optional and value-added services also can not be used in the prior art invention.

In order to solve the problems mentioned above for the prior art, this invention adopts an user identification module made up of a thin film circuit board in association with a control chip, it can be used within the mobile phone or used together with user identification card; moreover, the control chip is pre-integrated and built in with functions or items include: the operational interface, functional selection items and application data of original number; and data, new user operational interface, functional selection items, application data, etc. for more than one number which is different the original number; therefore, when the user combines and fixes the user identification card (SIM card) to the user identification module, the electrical connection point links the user identification chip of user identification card to the control chip, it can thus provide the user a diversified and totally new function and operational interface application as well as the selection, use and switching of multi-number, and finally, the convenience of use and practical purpose can thus be reached.

In order to let people to further understand the purpose, structure, device features and the function this invention tries to reach, we thus present a better embodiment accompanied with the drawings and describe them in detail as in the followings:

### BRIEF DESCRIPTION OF THE DRAWING

FIG. 1 shows an appearance drawing of a prior art embodiment.

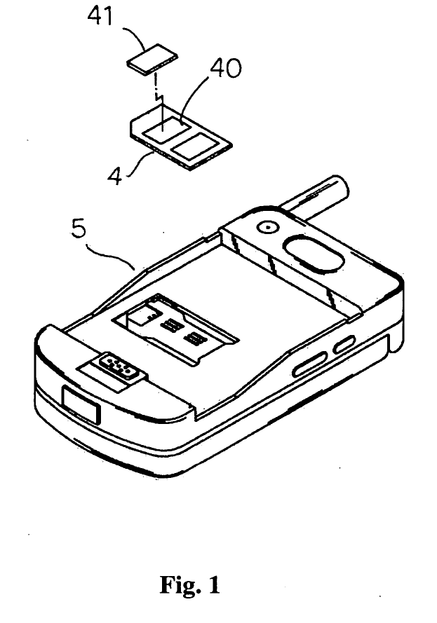

FIG. 2 shows an appearance drawing of another prior art embodiment.

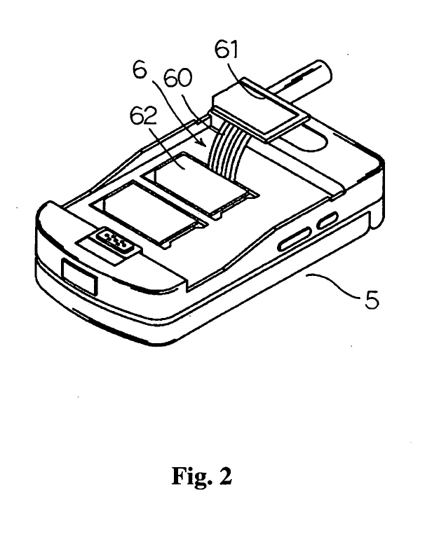

FIG. 3 shows a structural decomposition drawing of a better embodiment of the current invention.

FIG. 4 shows a functional block diagram of a better embodiment of the current invention.

FIG. 5 shows another functional block diagram of a better embodiment of the current invention.

FIG. 6 shows yet another functional block diagram of a better embodiment of the current invention.

### DETAILED DESCRIPTION OF THE PREFERRED EMBODIMENT

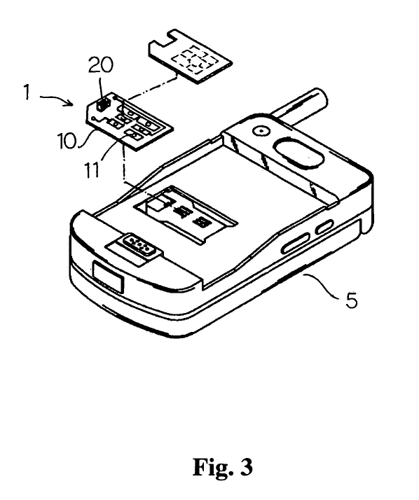

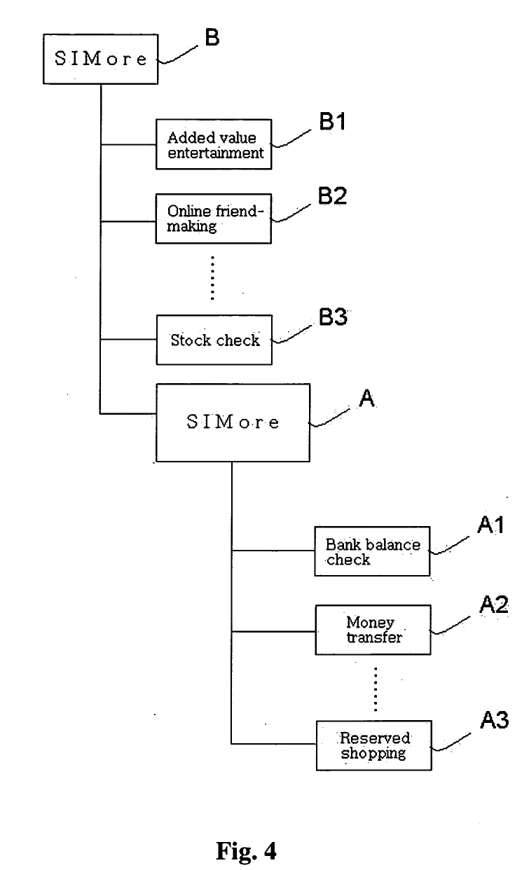

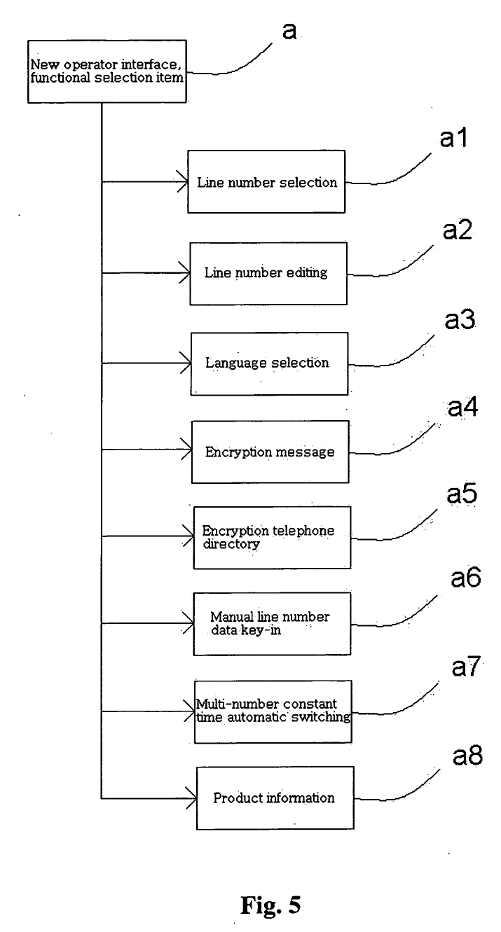

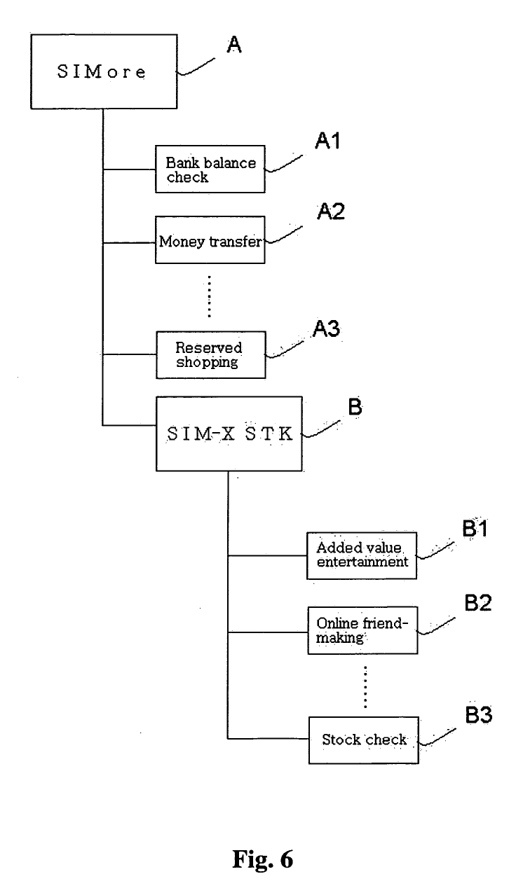

This invention is to provide a brand new functional module structural improvement for expanded and enhanced SIM card, please refer to the structural decomposition drawing for an embodiment as in FIG. 3: the structure as in the figure is basically an user identification module (1) containing a thin film circuit board (10) in association with a control chip (20), the user identification module (1) has a size the same as user identification card (SIM card), and its surface is installed with electrical connection points (11) and a control chip (20), the electrical connection points (11) match the user identification chip of the user identification card so that it can form an electrical connection with the control chip (20), moreover, the inside of the control chip (20) is pre-integrated and built in with: operational interface and functional selection items (A), application information (B) of the original line number, and more than one sets of new number information, operational interfaces, functional selection items (a), application information (b) which are different than the original number; wherein the operational interface, functional selection item (A) and application information (B) of the original number are as shown in FIG. 4, the application information which can be integrated by the user identification chip of the original number include: added value entertainment (B1), on-line friend-making (B2), stock check (B3) etc., and the operational interface includes bank balance check (A1), money transfer (A2), reserved shopping (A3), etc. The application interface and functional selection items of newly added number are as shown in FIG. 5, they include: line number selection (a1), line number editing (a2), language selection (a3), encryption message (a4), encryption. telephone directory (a5), Manual line number data key-in (a6), multi-number constant time automatic switching (a7), production information (a8) and related application operational interface; the application information and operational interface are the same as the original line number, this is as shown in FIG. 6.

In the structural design of the user identification module of the current invention, we try not to destroy the appearance and structure of the original SIM card and keep its integrity and remain its stability, we set the control chip at a location not to affect the user identification chip so as to enhance cutting safety and prevent its reception of other damage; moreover, we adopt the thin film circuit board design and reduce the thickness of the original user identification module, therefore, there is not installation difficulty and appearance problem, this in turn enhance product quality and its competitiveness in the market. Most importantly, a SIM card is used in association with an expandable control chip, it not only achieves the basic function of multi-number switching use but also achieves the information editing, amending and related operation and use on different line number through the new operational interface and functional selection items preset within the control chip, this is to fully meet the diversified user need.

To summarize, we know that the current invention of “A functional module structural improvement for expanded and enhanced SIM card” does provide an unseen innovative structure, the function it achieves can not be reached by the prior art. It possesses both innovation as well as progressiveness, we thus present this application.

However, the above mentioned is just a better embodiment of the current invention, it is not used to limit the scope of the current invention, any equivalent amendment or change based on the spirit of the current invention should be seen as falling within the scope of what is claimed.

What is claimed is:

1. A functional module structural improvement for expanded and enhanced SIM card mainly uses a thin film circuit board in association with s control chip to form an user identification module having the following features:
The user identification module has the same size as the size of the general user identification card (SIM card), its surface is installed with electrical connection points and a control chip, the electrical connection points match the user identification chip of the user identification card so that it can form an electrical integration with the control chip, moreover, the inside of the control chip is pre-integrated and built in with: operational interface and functional selection items, application information of the original line number, and more than one sets of new number information, operational interfaces, functional selection items, application information.

2. The functional module structural improvement for expanded and enhanced SIM card of claim 1 wherein the especial thing is the functional selection items of the newly added line number, these include: line number selection, line number editing, language selection, encryption message, encryption telephone directory, manual line number data key-in, multi-number constant time automatic switching, product information and related application operational interface.
